(19) United States
(12) Patent Application Publication
(10) Pub. No.: US 2009/0126992 A1
(43) Pub. Date: May 21, 2009

(54) Device for Sealing of Inserted Cables, Conduits or Pipes

(76) Inventor: Olaf Horn, Ammersbek (DE)

Correspondence Address: HARNESS, DICKEY & PIERCE, P.L.C., P.O. BOX 8910, RESTON, VA, 20195, US

(21) Appl. No.: 12/086,754

(22) PCT Filed: Dec. 19, 2006
(86) PCT No.: PCT/SE2006/050594

§ 371 Date: Dec. 9, 2008

(30) Foreign Application Priority Data
Dec. 21, 2005 (DE) 10 2005 062 656.4

(51) Int. Cl. H02G 3/02

(52) U.S. Cl. 174/656

(57) ABSTRACT

In a device for sealing of conduits inserted in circular lead-throughs of walls and roofs designed as frame (1) it is provided for the arrangement of a plug formed sealing body (2) of elastic material which forms a quadrangular pack accommodation (7). In the pack accommodation (7) elastic splitted modules (4) in square form are inserted with received conduits (3) and arranged sealingly by means of clamping elements acting on the sealing body (2). To increase the pack accommodation (7) for an assembly and disassembly of the modules (4) it is so provided, that at least one boundary side of the pack accommodation (7) forms a wedge formed free space (8) for receiving an insertable wedge element (9) after assembly of the modules (4).

The invention concerns a device for sealing of inserted cables, conduits or pipes in circular lead-throughs for walls and roofs formed as frames with an inserted, plug formed sealing body of elastic material and forming a quadrangular pack accommodation for wholly or partially elastic modules arranged between the cables, conduits or pipes as splitted fitting pieces in square form in a modular arrangement above and/or adjacent to each other, which modules by means of pressure elements and displaceable clamping elements and by means of the sealing body in the plane of the frame clamp the received elements sealingly in the frame.

Devices of this kind are known in numerous designs. In DE GM 88 09 629 U1 a sealing for cable lead-throughs for circular frames of wall lead-throughs is shown. Wherein a plug formed sealing body of elastically workable material and having a quadrangular accommodation space for provided insertable splitted fitting pieces is arranged for receiving cables and the like, which are possible to sealingly clamp by means of clamping elements acting on the sealing body, in order to achieve a tightness against fire, water and gas. The deficiency of devices of this kind lies therein, that it is only laboriously possible to get the parting lines of the separate modules as a column at the assembly in the allowed accommodation space, especially at an assembly of the last module row. Also a change or a disassembly of the modules causes difficulties.

The object of the invention is to improve a device of this kind and in a simple way give an expansion of the assembly volume as well as with retention of a similar clamping force guarantee a sealing and make an assembly simplification possible.

The solution to this object according to the invention is that at least one boundary side of the pack accommodation for the modules shows a wedge formed free space for receiving an insertable corresponding wedge element after assembly of the modules.

Hereby assembly and disassembly is simplified, whereby it is possible to handle the modules in a larger assembly volume.

An advantageous design is accomplished in that the wedge formed free space for receiving the wedge element is formed above or under above each other arranged parting lines of the modules.

To guarantee simple removal of the inserted wedge element, it is proposed that the pack accommodation has a gouge as access for handling of the inserted wedge element.

In further developments, it is also so arranged that the wedge element has a corresponding cavity to the gouge in the pack accommodation.

In the drawings one embodiment of the invention is represented. In the drawings:

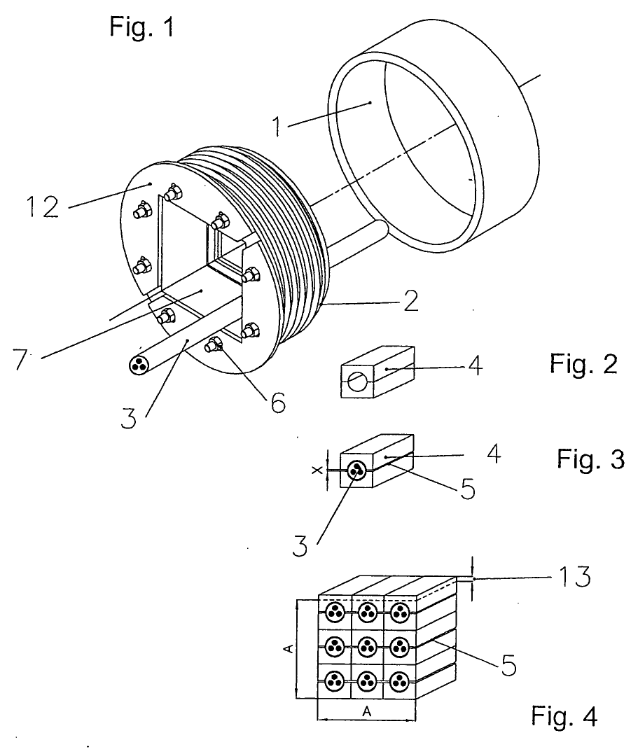

FIG. 1 is a diagrammatic representation of a device having frame, sealing body and provided cable;

FIG. 2 shows a module for insertion as splitted fitting piece;

FIG. 3 is a representation as FIG. 2 with inserted cable;

FIG. 4 shows a number of modules, in the way as they are arranged for insertion in the pack accommodation of the sealing body;

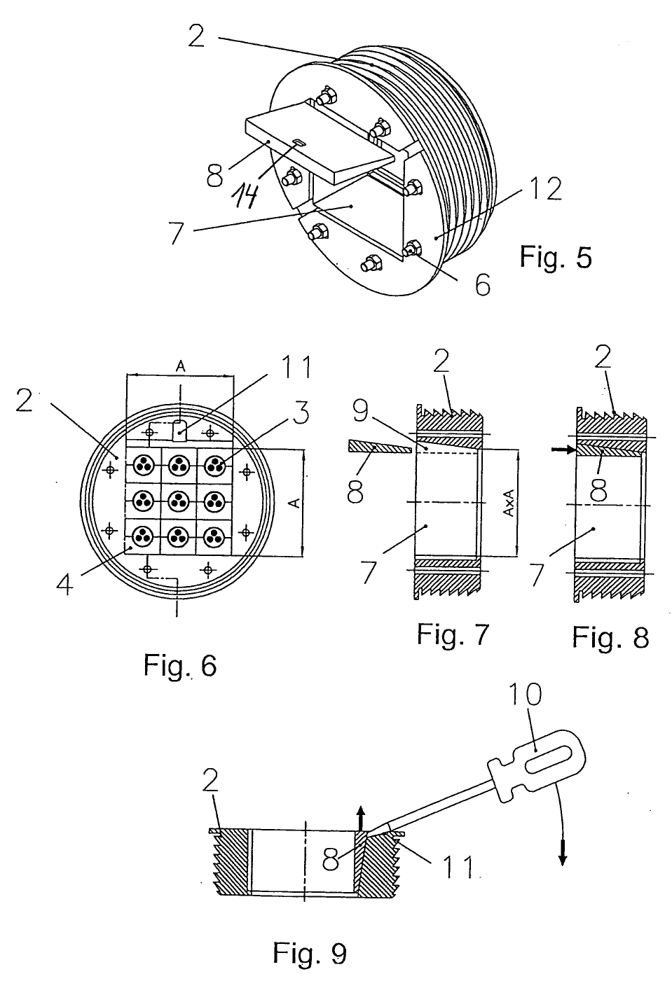

FIG. 5 is a perspective representation of an insertable sealing body with provided wedge element before the insertion;

FIG. 6 is a plan view of a sealing body with inserted modules;

FIGS. 7 and 8 is a cross-section according to FIG. 6 with provided and inserted wedge element; and

FIG. 9 is a diagrammatic representation of removal of the wedge element.

A frame 1 is arranged in the shown device, which is placed fixed in a not shown wall. This frame 1 receives a corresponding plug formed sealing body 2 of elastic material, which has a central quadratic pack accommodation 7 and which serves as accommodation for modular arranged insertion modules 4 as splitted fitting pieces for cables 3 to be lead through.

The sealing body 2 has pressure plates 12 arranged on both sides, which by means of screws 6 as clamping elements diminish the cross-sectional area of the pack accommodation 7 and also compress the inserted modules 4, in order to achieve tightness with the inserted cables 3 against fire, water and gas.

The choice of modules 4 is done depending on the diameter of the cables 3, in such a way that there will be an air gap 5 between the module halves of the modules 4 before the clamping. If several layers of modules 4 are formed inside the quadratic pack accommodation 7, the separate air gapes 5 with the measurement x will then be summarized to a sum 13 of several millimetres and increase the normal dimension A. This leads to that the assembly of the last row of modules only is possible under complicated conditions.

Therefore it is so arranged, that a wedge formed free space 9 is arranged above one of the above each other arranged air gaps 5 as parting lines of the modules 4, which acts to receive a insertable corresponding wedge element 8 after assembly of the modules 4.

Through this feature it is possible to increase the assembly space in the sealing body 2, whereby by means of the wedge element 8 to be inserted the enlargement can be closed again after assembly. Thereafter a clamping of the lead-through is possible in a known way.

A simple disassembly of the wedge element 8 is guaranteed through a gouge 11 in the sealing body 2, which makes it possible to lift the wedge element 8 with a screwdriver 10 and gives the necessary stress relief for the modules 4, so that they easily may be removed again and/or exchanged. For this the wedge element 8 is also combined with a cavity 14.

Differing from this embodiment it is of course also possible to arrange wedge elements 8 on more sides of the pack accommodation 8 to increase the accommodation space.

1. A device for sealing of inserted cables, conduits or pipes in circular lead-throughs for walls and roofs formed as frames with an inserted, plug formed sealing body of elastic material and forming a quadrangular pack accommodation for wholly or partially elastic modules arranged between the cables, conduits or pipes as splitted fitting pieces in square form in a modular arrangement above and/or adjacent to each other, which modules by means of pressure elements and displaceable clamping elements and by means of the sealing body in the plane of the frame clamp the received elements sealingly in the frame, wherein at least one boundary side of the pack accommodation for the modules shows a wedge formed free space for receiving an insertable corresponding wedge element after assembly of the modules.

2. The device of claim 1, wherein the wedge formed free space to receive the wedge element is formed over or under above each other arranged parting lines of the modules.

3. The device of claim 1, wherein the pack accommodation has a gouge as access for handling of the inserted wedge element.

4. The device of claim 3, wherein the wedge element has a cavity corresponding to the gouge in the pack accommodation.
